(19) United States
(12) Patent Application Publication
(10) Pub. No.: US 2008/0263648 A1
(43) Pub. Date: Oct. 23, 2008

(54) SECURE CONFERENCING OVER IP-BASED NETWORKS

(75) Inventors: Jithesh Sathyan, Kollam (IN); Harish Sathyan, Kollam (IN); Naveen Krishnan Unni, Bangalore (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 12/105,205

(22) Filed: Apr. 17, 2008

(30) Foreign Application Priority Data
Apr. 17, 2007 (IN) 835/CHE/2007

(51) Int. Cl. H04L 9/32; G06F 21/00

(52) U.S. Cl. 726/7

(57) ABSTRACT

Methods and systems for secure conferencing over an IMS network or other networks include sending request by at least one user to access to an application server. The user is validated using a validation coupon provided by the user equipment followed by identifying and allowing the user equipment to download a valid media client. Conference data is encrypted and transmitted to the user equipment, and processed by the media client. Typically, the encrypted conference data is decrypted by the media client and communicated to a user interface presentation to the user. In some examples, the conference data is validated prior to downloading to the user equipment.

### CROSS REFERENCE TO RELATED APPLICATION

This application claims the benefit of Indian patent application 835/CHE/2007, filed Apr. 18, 2007, that is incorporated herein by reference.

### TECHNICAL FIELD

The present invention relates to methods and apparatus for conferencing, and more particularly, to methods and apparatus for secure video conferencing over an Internet Protocol (IP) multimedia subsystem (IMS) network and other networks.

### BACKGROUND

In a typical business scenario, workday meetings are common between company employees, customers, vendors, or consultants, or between employees and their managers, or among members of project teams. Meeting participants may be either in one geographical location or in several geographical locations. Bringing meeting participants together at a common location may involve extensive travel. However, travel for such meetings has many disadvantages such as reduced employee productivity and high cost.

Virtual meetings such as video conferences can address these problems. The rapid spread of Internet Protocol (IP) based access technologies as well as the move towards core network convergence with the IP Multimedia Subsystem (IMS) network as designed by the 3^{rd} Generation Partnership Project (3GPP) has led to increased multimedia content delivery via packet networks. These IP-based technologies can provide a rich experience for conference participants. However, the security vulnerabilities associated with such conferencing may permit an attacker to eavesdrop on, disrupt, or gain control of such meetings. Thus, this sophisticated conferencing infrastructure can undesirably serve as a video surveillance unit, using user equipment to snoop on, record, or publicly broadcast private video conferences.

Security attacks for video conferencing include denial of service (DOS) attacks, abuse of service attacks, and interception and modification attacks. The conventional methods available to address these attacks are generally based on a security gateway or additional security features on each of the components in the IMS network. Having security features at each IMS network component is associated with large overheads. Hence, the use of the security gateway as the only entry point to the IMS network is the most common method of defense. In this case, the security gateway is a core component for secure video conferencing between the components in an IMS network, one or more access networks, and the Internet. Unfortunately, the use of security gateways has significant disadvantages. Any problems in the security gateway can disrupt communications, and the security gateway itself may require considerable processing power as it serves as a central point for communication. In addition, a video conferencing user must accept the additional cost and risk of the security gateway and assume that the security gateway is always well behaved.

For at least these reasons, improved methods and apparatus are needed for secure video conferencing.

### SUMMARY

Methods of secure conferencing comprise validating at least one user based on a validation coupon provided by user equipment associated with the at least one user, and transmitting an authorization associated with the at least one user based on the validation, wherein the transmitted authorization is associated with download of a media client. In some examples, the media client is based on the validation coupon provided by the user equipment. In further examples, the media client is configured to receive the validation coupon and determine that the media client is valid with respect to the validation coupon. In additional examples, the validation is associated with access to an application server, and the media client is configured to access the application server. In other examples, a connection request associated with establishing communications with the user equipment based on the media client is received. In additional examples, the connection request is associated with providing conference data to the user equipment, and encrypted conference data is transmitted to the user equipment, wherein the encrypted conference data is encrypted based on the validation coupon. In further representative examples, at least one of the validation coupon and the user authorization is communicated via an Internet Protocol (IP) based network.

In still other examples, the IP based network includes at least one of an IP multimedia subsystem network (IMS network) or a packet based network and the validation coupon includes at least one of a user identity, an equipment identity, and a shared key associated with a plurality of devices. In some examples, the validation coupon includes a user identity and an equipment identity, and the equipment identity is an International Mobile Equipment Identity (IMEI). In typical examples, the authorization is transmitted to the user equipment.

User stations comprise a memory configured to store an equipment identifier associated with the user station, and a transceiver configured to transmit a request for services that includes a validation coupon, wherein the validation coupon comprises the equipment identifier. In some examples, the transceiver is configured to receive a media client in response to the request, wherein the media client is based on the validation coupon. In other alternatives, a processor is configured to execute the media client such that data to be transmitted to the user station is validated based on the validation coupon prior to transmission, and the transceiver transmits a transmission authorization based on the data validation. In some examples, the equipment identifier is associated with user equipment for two or more users. In additional examples, the transceiver is configured to receive the public identifier, and the processor is configured to store the public identifier in the memory. In further examples, the processor is configured to receive encrypted data and decrypt the data based on the media client and the validation coupon.

Application servers comprise a validation module configured to receive a validation coupon and determine if a user is authorized to access services provided by the application server. A download module is configured to communicate a media client to a user, wherein the download module configures the media client to process media data based on at least a portion of the validation coupon. In additional examples, a media control module is configured to deliver the media data based on at least a portion of the validation coupon. In further examples, the media control module is configured to deliver the media data based on at least one of a public identifier and an equipment identifier. In some examples, the media data is audio data, video data, text data, or image data, and in other examples, the media data is delivered based on a Real Time Transport Protocol or a Real Time Streaming Protocol.

Application servers configured to provide conference data comprise a conference control module that distributes conference data and a media client download module that is configured to authorize a plurality of user stations to download a valid media client upon successful validation of a validation coupon. A water mark module is configured to encrypt the conference data using the validation coupon and communicate the encrypted data to the plurality of user stations. In additional examples, the media client download module provides a media client configured to decrypt encrypted data provided by the application server. In other examples, a filter module is configured to receive the validation coupon and authorize download to the associated user and user station. In other examples, a decoder is provided for decrypting requests for services received from the user stations. In still further examples, the valid media client includes a validator to determine if the conference data is valid with respect to the plurality of user stations, and the media client is configured to deliver the conference data upon data validation. In some examples, the valid media client is configured based on a media key provided by a content provider.

Computer program products comprise a computer readable medium having a computer readable program code embodied therein for a method comprising validating a plurality of users for access to an application server based on validation coupons provided by a corresponding plurality of user stations. The plurality of user stations are enabled to download a valid media client from the application server after successful validation, wherein the valid media client for each user station is configured to decrypt conference data based on the validation coupon associated with the user station. The conference data for each of the user stations is encrypted using the validation coupons provided by the plurality of user stations, and the encrypted conference data is downloaded to the plurality user stations. The conference data is decrypted and coupled to a user interface at each of the plurality of user stations.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1A is a block diagram showing a representative network configured for secure conferencing among a plurality of users.

FIG. 1B is a block diagram illustrating a representative application server configured to provide secure services or content in a communication network such as the network of FIG. 1A.

FIG. 1C is a block diagram illustrating representative user station configured to request and receive services or content in association with secure conferencing in a communication network such as the network of FIG. 1A.

FIG. 2 is block diagram illustrating a representative method for secure conferencing.

FIG. 3 is a block diagram illustrating a representative generalized computing environment configured to implement the disclosed methods.

### DETAILED DESCRIPTION

As used in this application and in the claims, the singular forms “a,” “an,” and “the” include the plural forms unless the context clearly dictates otherwise. Additionally, the term “includes” means “comprises.”

The described systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods which function in the manner described by such theories of operation.

The present disclosure relates generally to secure environments for conferencing over a network and, in a particular example, for secure video conferencing over an IP Multimedia Subsystem (IMS) network as designed by the 3^{rd} Generation Partnership Project (3GPP). The following description is presented to enable a person of ordinary skill in the art to make and use the technology. Various modifications to the disclosed embodiments will be readily apparent to those skilled in the art and the generic principles may be applied to other embodiments. Accordingly, the disclosed technology is not intended to be limited to the embodiments shown but is to be accorded the widest scope consistent with the principles and features described herein.

### Representative Network Configurations

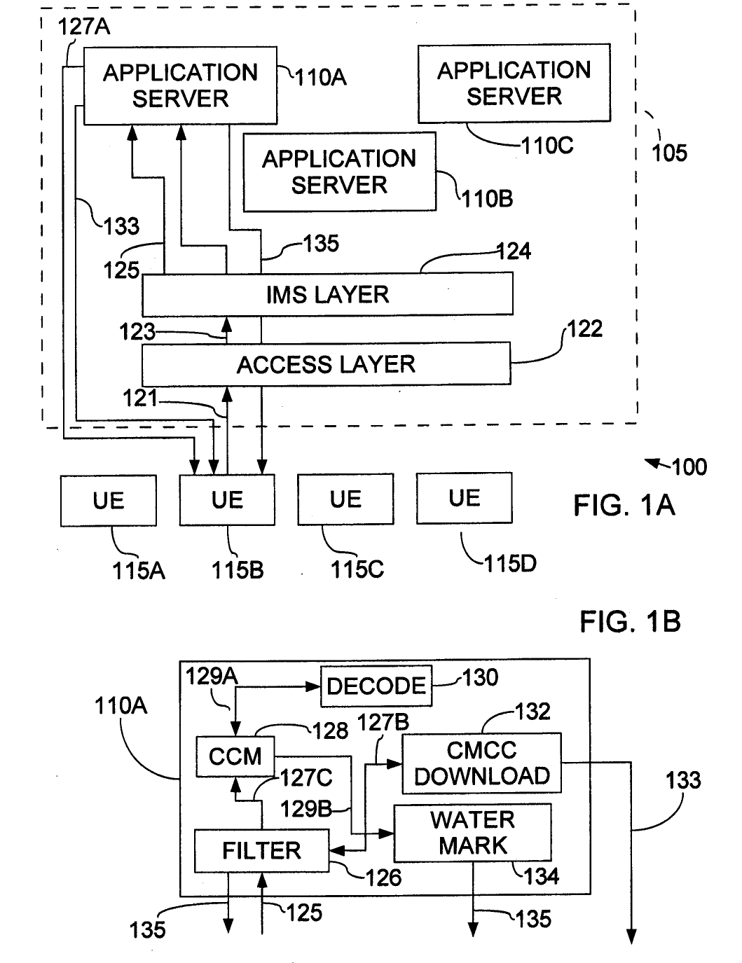

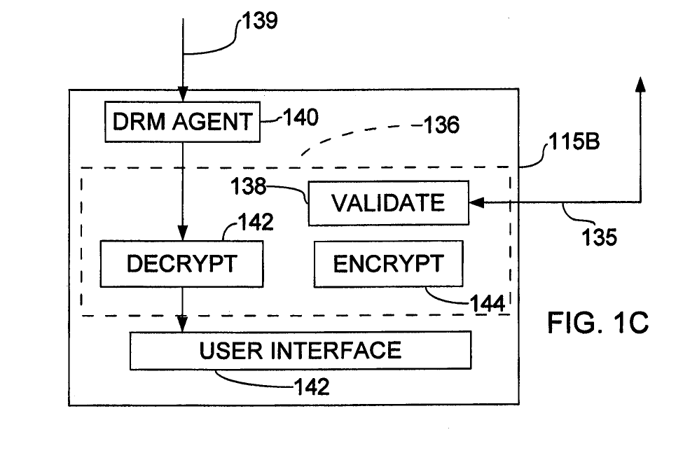

With reference to FIG. 1A, a secure conferencing system 100 is configured for conferencing over a network 105 such as, for example, the Internet or other public or private network including but not limited to wireless, wired, and cellular networks. The system 100 comprises application servers 110A-110C, user equipment 115A-115D (referred to hereinafter generally as “user equipment,” “user stations,” or “stations”) configured to serve one or more users. In the example of FIG. 1A, three application servers and user equipment for four users is illustrated, but more or fewer application servers and user equipment can be provided. User equipment can be provided as cellular telephones, voice over IP telephones, palm top or hand held computers, laptop computers, desktop computers, servers, or other communication devices. Such devices generally include a receiver and transmitter (referred to herein as a transceiver) configured to send and receive data. Transceivers can be coupled to transmit and receive based on wired, wireless, optical or other signal types. In some examples, user equipment is provided as a cellular telephone, mobile station, or other communication device that includes or is coupled to a subscriber identity module (SIM) that includes a computer readable medium that stores an international mobile subscriber identity (IMSI) or other user or equipment identifiers. In some examples, SIM memory stores one or more device identifiers such as an international mobile equipment identifier (IMEI) that is associated with a particular communication device, or a SIM device identifier such as a SIM serial number. Communication connections for typical networks over which secure conferencing is provided can be based on wired or wireless network protocols such as Ethernet, WiFi, GSM, or other protocols and combinations thereof. For convenience, FIG. 1A illustrates communications associated with the application server 110A and the user equipment 115B, and communications to and from other devices are not shown.

In one embodiment, the network 105 may be an Internet protocol (IP) based network such as an IP multimedia subsystem network (herein referred to as an “IMS network”) or a packet based network (herein referred to as “packet network”). However, it will be apparent to one skilled in the art that the network 105 may be any suitable network. In a typical example, the IMS network is conveniently a standardized next generation networking architecture based on open standard IP protocols as defined by an Internet Engineering Task Force (herein referred as “IETF”). The IP protocols defined by the IETF provision a multimedia session or content exchange (for example a secure conference) between two or more users on the IMS network, between a user and the Internet, or between two or more users on the Internet.

The IMS network generally implements procedures and provides and processes communications that can be described with reference to three or more networking layers: a service layer, an access layer 122 (also known as “transport layer”) and an IMS layer 124 (also known as “control layer”). The service layer of the IMS network generally comprises multiple application servers such as the application servers 110A-110C so that a service provider (also known as a “content provider”) can introduce new services or new content (for example, conference data for a secure conference) by adding a dedicated server or provisioning a currently available server to provide such services. The service layer permits each user to access requested services or content at the appropriate application server via their user equipment so that content or services can be provided. In addition, the service layer can be configured to manage information relating to user presence and location so that services and content are directed to the appropriate user location and user communication device.

The access layer 122 (also referred to as the transport layer) is configured to initiate and terminate a session initiation protocol (hereinafter referred to as “SIP”), and provide multimedia content either in a digital format, an analog format, a packet data format such as an IP packet format, or other format to the users. The access layer 122 is configured to allow communication between components of the IMS network 105 and the user equipment 115A-115D through, for example, a real time protocol (hereinafter referred to as “RTP”) and stream control using a real time streaming protocol (hereinafter referred to as “RTSP”). As shown in FIG. 1A, in a representative example, a request from the user equipment 115B may be encrypted in an encryptor provided in the user equipment 115B and that is forwarded to the access layer 122 in a communication 121. The encryptor can be implemented in hardware, software, or a combination thereof and is described in detail below.

The IMS layer 124 (the control layer) generally comprises a call session control function (herein referred as “CSCF”) and a home subscriber server (herein referred as “HSS”). The CSCF handles Session Initiation Protocol (SIP) registration of the application server and processes SIP messaging for the application servers 110A-110C in the service layer. The HSS server typically includes a database configured to store a unique service profile for each user. The service profile may include a user's IP address, telephone records, friend or buddy lists, voice mail greetings, ring tones, service and content subscriptions, billing information, etc. In one example, a communication 123 is sent to the IMS layer 124 from the access layer 122 in response to the request 121 from the user equipment 115B for processing by the HSS database to provide coordinated services and content to a user. For example, personal directories and centralized user data can be provided for some or all services available in the IMS network.

The packet networks mentioned in the description of representative embodiments can be configured to communicate data, voice, video, or other media or combinations thereof using IP packets. However, other packet network configurations can be used, and the disclosed technology is not limited to IP packet networks or the transmission of any particular type of content.

As shown in FIG. 1B, the representative application server 110A comprises a filter module 126, a conference control module (CCM) 128, a decoder 130, a custom media conference client (herein referred as “CMCC”) download module 132, and a water mark module 134. Other application server hardware or software components such as a processor, input/output devices, memory, and network hardware are typically provided, but are omitted from FIG. 1B for clarity. Modules and components such as described above can be provided as sets of computer executable instructions that are configured for execution on one or more processors associated with one or more servers, personal computers, dedicated microprocessors, or other processing devices. Such instructions are typically stored in computer readable media such as floppy disks, CDs, DVDs, hard disks, random access memory (RAM), programmable read-only memory, or other media. In other examples, modules and components are provided as or in conjunction with dedicated hardware that is configured to, for example, code and decode communications or provide water marks. For example, a dedicated processor can be provided for encryption or decryption or other functions. In some examples, an application server processor is configured to perform such functions based on appropriate software modules and hardware components as well as handling other tasks. In some examples, one or more modules can be included in client software that resides at a user station for execution at a processor located at the user station.

The filter 126 is configured to receive a communication from a user that can include a validation coupon associated with user service or content authorization. Based on the validation coupon, the application server 110A can permit full or partial access to services or content associated with the application server 110A, or deny access. The validation coupon may comprise an equipment identity (hereinafter referred to as a “device ID”) or a subscriber identity (hereinafter referred to as a “public ID”) or combination of both. In some examples, the filter 126 is configured to process a validation coupon that includes one or more of an International Mobile Subscriber Identity (IMSI), an International Mobile Equipment Identifier (IMEI), or other public ID or device ID of a subscriber or subscriber equipment. As shown in FIGS. 1A-1B, if the filter 126 determines that a received validation coupon does not include a suitable identifier, the filter 126 can deny access and transmit a message 135 to the user to indicate that access is denied. In some examples, an access denial message includes identifiers, error codes, or other indications associated with access denial. For example, the access denial message can indicate that a public ID or equipment ID is invalid, or invalid with respect to the requested services, or that the requested content and/or services are currently unavailable. In addition, the application server 110B can communicate guidelines or other general considerations to a user to aid a user in accessing content or services in subsequent access attempts.

The conference control module (CCM) 128 is configured to manage conference data. Typically, a service provider or a content provider provides conference data and services based on the CCM 128. Conference data can include audio conferencing data, video conferencing data, or other data such as text and numerical data, or combinations thereof. In a representative example, the filter 126 is configured to issue a communication 127C to the CCM 128 which is forwarded to the decoder 130. In a bidirectional communication 129A, the decoder 130 receives the forwarded message and returns a decoded message to the CCM 130. In addition, the CCM 128 is coupled to forward conference data (such as audio, video, and/or text and numeric data) in a communication 129B to the water mark module 134, for encryption or water marking of conference data.

The decoder 130 is configured to decrypt the request received from the conference control module 128 in the communication 129A. As shown in FIG. 1B, the decoder 130 is a separate hardware or software module (or combination thereof) that can be provided as a dedicated processor or an additional software module for execution on a general purpose processor. In other examples, decoder functions can be included in the conference control module 128.

In one example, the CMCC download module 132 is configured to provide a valid CMCC to a user in a communication 133. The CMCC download module 132 is also coupled so as to communicate with user equipment to determine if a valid CMCC is available at the user equipment based on a CMCC key provided by a content provider or service provider. The CMCC key is typically a unique key comprising one or more numerals, alphabetic, or special characters or combinations thereof. Keys can also be implemented based on audio or image data or combinations of such data. The key is typically a unique key with respect to one or more selected service or content providers, and the key is typically provided only to a valid CMCC 136 downloaded from a particular application server.

In some examples, the CMCC download module 132 is configured to communicate with user equipment and to determine if a valid CMCC module has been installed on the user equipment. In some convenient examples, the CMCC download module 132 transmits a message to user equipment informing the user that a valid CMCC module is not yet available, advising the user that download of such a module should be requested in order to access requested content or services. The CMCC download module 132 can also provide notification of any additional steps that may be required or advisable in order to secure a valid CMCC. In some examples, the CMCC download module 132 is configured to communicate with a plurality of users to communicate the presence or absence of a valid CMC module at one or more user stations.

The water mark module 134 is configured to receive and encrypt conference data received through or authorized via the conference control module 128 after successful coupon validation by the filter 126. The module 134 is configured to modify, supplement, encrypt or otherwise process conference data based on one or both of a public ID and an equipment ID so that one or both of the public ID or the device ID are effectively embedded in the processed (encrypted) data so that the processed data can be associated with a particular user and user equipment. As marked in this manner, only a user and associated user equipment which has been authenticated for access to services or content can decrypt conference data. In one example, one or more water marks are provided so that user equipment can identify and process appropriate data while other data remains unprocessed. Typically, service or content related data is encrypted, and user equipment is configured to decode the encrypted data. In a representative example, encrypted service or content related data is validated in the user equipment as described below.

Particular services or content are generally provided to a user from a single server such as the server 110A or a combination of servers. In addition, services or content can be provided by one or more providers. The service provider and the content provider may be either different or the same. If the content provider and the service provider (and the associated servers are different), the server associated with the content provider (for example, the server 110A) may seek access to additional application servers via the conference control module 128 or be otherwise coupled to one or more application servers for additional services and content.

The user equipment 115A-115C, upon successful registration of a SIM card, can provide the device ID and the content provider can provide the public ID (or public IDs) for each of the application servers 110A-110C. The public IDs can be stored in memory provided in user equipment or stored in SIM memory, or public IDs can be provided manually by a subscriber. In one embodiment, a request sent from the user equipment 115B through the access layer 122 and IMS layer 124 is processed at the filter 126 to validate the user in a communication 125. The filter 126 can deny the user equipment 115A access to the application server 110 if the validation coupon provided by the user equipment 115A is invalid, as shown in FIG. 1A in a communication 127A.

Upon, successful validation of the user, the filter 126 can send a request 127B to the CMCC download module 132 to determine if a valid CMCC 136 is available in the user equipment in a communication 133 to the user equipment 115B as illustrated in FIGS. 1A-1C. Based on the reply to the request 127B from the CMCC download module 132, the filter 126 may enable conference control module 128 in a communication 127C.

With reference to FIG. 1C, the representative communication device or user equipment 115B (referred to hereinafter as “station”) comprises a digital rights management (“DRM”) agent 140, a valid CMCC 136, and a user interface 142. The CMCC 136 is generally obtained from an application server associated with requested services or content. The CMCC 136 further comprises a validator 138, a decryptor 142, and an encryptor 144 that can be provided as one or more software modules configured for execution on a general purpose processor provided in the station 115B, or in conjunction with a dedicated processor for one or more specific functions. Other components of the station 115B such as specific input/output devices, keypads, displays, internal memory, external memory, microprocessors, network components, etc. are not illustrated.

The validator 138 is configured to validate conference data before downloading conference data into the station 115B via a communication 135 with the water mark module 134. Validation generally includes determining that the data to be downloaded is data intended for the station 115B. Validation is based on the validation coupon provided by the station 115B after querying the valid CMCC 136 in the station 115B. Typically, portions of a response from the CMCC 136 and a communication from the water mark module 134 or other application server module are compared to validate content. The response from the application server 110A may contain the validation coupon which the user equipment 115B has provided previously in a request to download the CMCC. Upon successful validation, the conference data is forwarded to the DRM agent 140 of the station 115B in a communication 139.

The DRM agent 140 is configured to enforce a plurality of access rights and limitations on the downloaded conference data. For example, the DRM agent 140 can be configured to enforce a plurality of parameters requested by a service provider or a content provider, or to enforce mandatory parameters such as those established in an Open Mobile Alliance (herein referred as “OMA”) DRM or combinations of such parameters. The parameters set by a service or content provider can include a time period (i.e., the number of hours, days, or months) for which the conference data is to remain valid for use by one or more users, a number of times conference data can be accessed by a user, whether the conference data or other content is associated with a particular type of content or services access subscription, or whether limited services or content are available as part of a demonstration or trial service or content subscription. Mandatory parameters set by the OMA DRM can be associated with, for example, granting or denying conference data forwarding to other stations associated with subscribers or non-subscribers. In addition, the DRM agent 140 can be configured to restrict data downloads into the station 115B, or to require that the station 115B access or reconnect to an application server in order to access data, including data stored at the station 115B or otherwise stored in memory associated with the user. In some examples, the DRM agent 140 can be configured to permit access to data a predetermined number of times, or to permit access only to a limited number of stations at a single time. The DRM agent 140 is conveniently provided at the station 115B and executes in response to receipt of conference data by the station 115B. Conference data can be unpackaged by the DRM agent 140, and/or stored in an encrypted or unencrypted format at the station 115. In some examples, data is partially decrypted based on a public ID or a device ID prior to storage so as to remain at least partially encrypted as stored. Typically, conference data is transmitted to the decryptor 142 that is provided in the valid CMCC 136 in a communication 141. The DRM agent 140 can be configured to provide other functions such as those listed in the 3^{rd} Generation Partnership Project (3GPP), and is not limited to the particular examples described herein.

The valid CMCC 136 downloaded into the station 115B permits decryption of downloaded conference data. In addition, the valid CMCC 136 can encrypt the request sent from the station 115B to the application server 110A. The encryption of the request and decryption of the conference data downloaded into the station 115B can be performed after querying with the valid CMCC 136. In one embodiment, the decryptor 142 decrypts the conference data downloaded into the station 115B using the validation coupon provided by the station 115B and transfers the conference data to the user interface 142. The encryptor 144 encrypts a request from the station 115B using the validation coupon and transmits an encrypted request 121 to the application server 110A.

The user interface 142 of the station 115B is configured to provide conference data to the user after processing by the decryptor 142. Typically, the user interface includes one or more of an audio or video input or output, a display, or software modules configured to process audio, video, images and other data. The user interface 142 can be integral with the station 115B or can be provided separately. For example, the user interface 142 can include a conventional media player, or one or more display or input/output devices that are coupled to the station 115B, and the disclosed examples should not be taken as limiting the scope of the disclosed technology.

In one embodiment of the disclosed methods and apparatus, secure video conferencing is provided via the application server 110A and the user equipment 115A-115D as shown in FIGS. 1A-1C. Authorized users are generally permitted access to all conference data or other related data in the application server 110A, but in some examples, additional validations may be required and can be processed by the CMCC 136.

### Representative Communication Methods

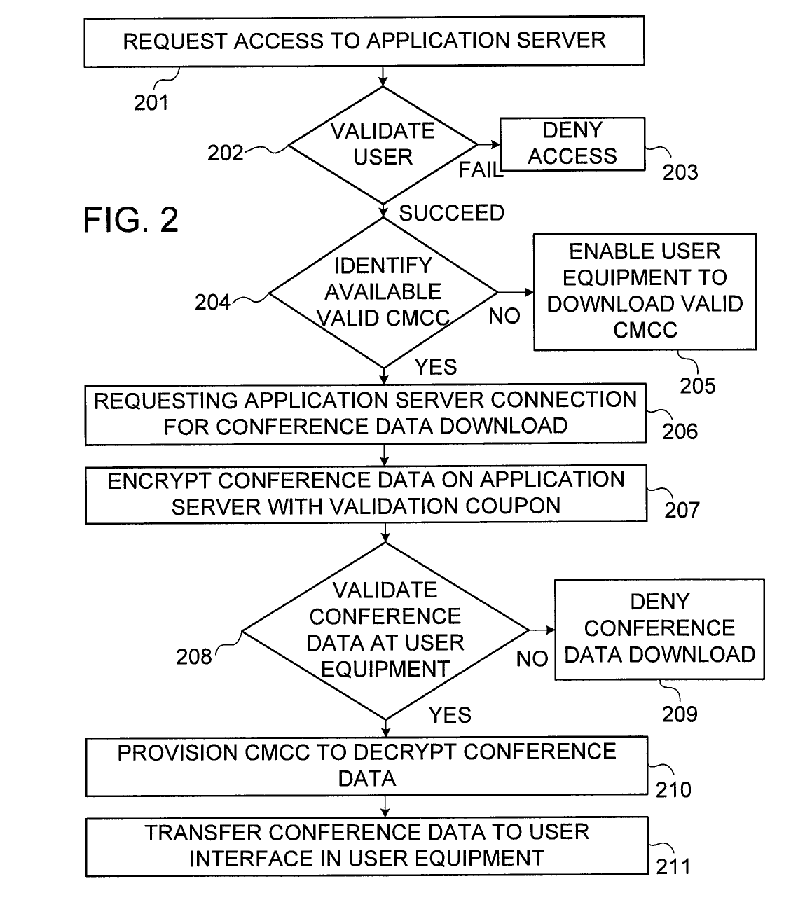

FIG. 2 is a block diagram illustrating a representative method for secure conferencing over an IMS network. As shown in FIG. 2, in a step 201, a user requests access to an application server, typically by forwarding a request that includes a validation coupon. In a step 202, the user is validated for access to the application server based on the validation coupon. Typically, the validation coupon includes one or more subscriber identifiers or equipment identifiers (or both). In some examples, validation is permitted only for a particular subscriber at a particular station. If the user is not validated, in a step 203 access is denied. In some examples, a voice, text, or other message is provide to the user to indicate why access was denied, and to provide recommendations concerning how to be granted access in subsequent access attempts.

In a step 204, the availability of a valid CMCC at the user station is determined. If a valid CMCC is not available at the user station, the station is enabled to download a valid CMCC in a step 205. Typically, the user is informed that such a download is necessary, and the user station is coupled or directed to a suitable network location for download of a valid CMCC. After the availability of a valid CMCC is confirmed, in a step 206, a request for a connection of the user station to download conference data is made. In a step 207, the conference data is encrypted, typically by an application server based on the validation coupon previously supplied. In step 208, conference data is validated at the user station. If validation is unsuccessful, download is denied in a step 209. Upon successful validation, the CMCC is provisioned to decrypt the conference data in the step 210, and conference data is transferred to a suitable user interface either in the user station or external to the user station in a step 211. These steps are described in more detail below.

In the step 201, the user requests access to an application server, typically by providing a validation coupon. If user cannot be validated in the step 202 because, for example, the wrong validation coupon has been provided, access is denied. In the step 203, the user can be informed that some or all portions of the validation coupon are invalid or not recognized so that the user can initiate an additional request. Alternatively, validation can fail because the user is not authorized to receive the particular requested services or content. In this case, the user can be notified that a subscription upgrade or other modification is necessary for access.

In the step 204, the availability of a valid CMCC in the user equipment is determined, typically through a CMCC download module. A CMCC key can be used to identify a valid CMCC in the user station, and can be a unique key for each service provider or content provider. If the user equipment does not have a valid CMCC, in the step 205 the user station is authorized to download a valid CMCC and downloads the CMCC. If a valid CMCC is already available, the user access request is processed and a connection is established between the user station and the application server so as to download conference in the step 206.

In the step 207, the conference data can be encrypted based on the validation coupon provided by the user station during validation using a water mark module. After encryption of the conference data, the encrypted conference data can be validated before downloading to the user station in the step 208. If the validation coupon provided by the user station obtained by, for example, a validation coupon query from the valid CMCC in the user station, does not match the validation coupon in the download message from the application server, the conference data download is denied in the step 209.

Upon successful validation of the conference data, the conference data can be downloaded into the user station and decrypted by the valid CMCC based on the validation coupon in the step 210. In final step after decryption, the conference data can be transferred to a user interface to present to the user in the step 211. The user can also send encrypted requests for services or content to an application server based on the validation coupon.

While in typical examples, each user and user station is provided with a unique validation coupon and a unique encryption/decryption key for each application server, in some network configurations such as a fixed mobile network (FMS), a shared key may be provided so that a user can access conference data at multiple user stations and the validation coupon can serve as a shared key for a plurality of user stations used to access applications such as conferencing applications.

Representative method can be described based on two users (“user 1” and “user 2”) who connect to an application server through their respective stations (referred to as “UE 1” and “UE 2,” respectively) over an IMS network. Either user 1 or user 2 sends a request to access a selected application server, and generally each user is validated before allowing access to the selected application server. User validation is typically based on a validation coupon provided by their respective user stations. If the validation coupons are in order, both users are allowed access to the application server. The users may send a request to the application server to download conference data. Once this request is received by the application server, the application server determines whether the users are authorized to access the requested conference data through a valid custom module conference control (CMCC) key provided by their respective stations in the request. The CMCC key is a unique key for each service provider or content provider who has contributed conference data accessed via the application server. If the key is not valid, the users are instructed to download a valid CMCC which will have valid CMCC key. If the stations have valid CMCCs, the application server allows the users to download the conference data. The conference data is encrypted in the application server before downloading to the user stations. The conference data encryption is performed using the validation coupon provided by the user stations. The stations can validate the conference data before downloading through their respective valid CMCCs using the validation coupon. Conference data can be viewed only after decrypting the data with the valid CMCC, and the users can view conference data using the user interfaces of their respective stations.

### Network Security Considerations

Typically, the methods and apparatus disclosed herein are not susceptible to common security attacks such as denial of service (DOS) attacks, abuse of service attacks, or attacks in which data is intercepted and modified. For example, in a DOS attack, an attacker may send a request for services to an application server and provide an identifier associated with a user identifier of an authorized user. In this attack, a request to direct conference data to a different user device is made. However, after making such a request, the attacker must download a valid CMCC and this request is checked and denied based on the invalid validation coupon supplied by the attacker. Thus, the attacker is unable to prompt the application server to provide services, and disruption normally associated with DOS attacks is substantially reduced. Another type of DOS attack may involve a session tear down in which an attacker sends a request to discontinue communications to an application server currently being accessed by a user station. This attack is unsuccessful because the attacker does not have a valid CMCC with which to make proper requests or to properly encrypt, decrypt, or otherwise format messages.

Abuse of service attacks include identity theft, replay attacks, proxy impersonation, or attempts to bypass refused consent, to use a false caller identity, to request unauthorized services, or to send spam as spam over Internet Telephony (SPIT). Identity theft is avoided due to the validation coupon that is based on user equipment not just an external input that can be provided by an attacker. Other impersonation related attacks (false caller ID, deceiving billing, proxy impersonation, bypassing refused consent, and improper access) are similarly impeded. SPIT has been raised as a serious issue for the IMS network. Only a valid users can generate SPIT because a valid CMCC is unavailable to an attacker. In some examples, an additional filter module or additional filter capabilities can restrict repetitive messages or limit the timing for sending messages. With a proper algorithms in the CMCC 136, SPIT can be substantially eliminated.

Interception and modification attacks such as signal spying, call content eavesdropping and a key manipulation can also be reduced or eliminated. In the disclosed examples, successful user/application server connection is typically based on a valid CMCC, and an attacker cannot intercept and modify of conference data or content as a valid CMCC is not generally available to an attacker.

### Exemplary Computing Environments

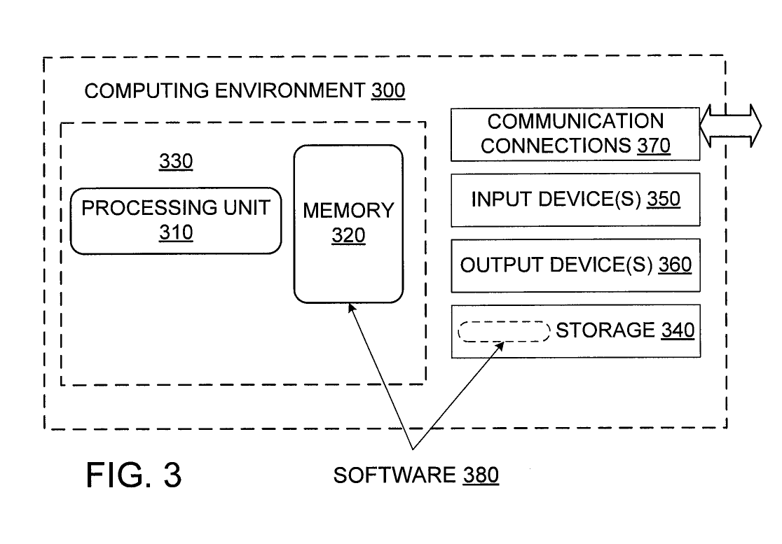

One or more of the above-described techniques may be implemented in or involve one or more computer systems. FIG. 3 illustrates a generalized example of a computing environment 300 that can be configured to implement the disclosed methods or serve as user equipment or an application server. Referring to FIG. 3, a computing environment 300 includes at least one processing unit 310 and memory 320. The processing unit 310 is configured to execute computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 320 stores software 380 that includes computer-executable instructions for one or more of the techniques described above.

The computing environment 300 typically has additional features such as storage 340, one or more input devices 350, one or more output devices 360, and one or more communication connections 370. An interconnection mechanism (not shown) such as a bus, controller, or network is configured to interconnect the components of the computing environment 300. Typically, operating system software (not shown) provides an operating environment for other software executing in the computing environment 300, and coordinates activities of the components of the computing environment 300.

The storage 340 may be removable or non-removable, and can include magnetic disks, magnetic tapes or cassettes, CD-ROMs, CD-RWs, DVDs, or any other medium which may be used to store information or computer-executable instructions which may be accessed within the computing environment 300. In some embodiments, the storage 340 stores computer-executable instructions associated with one or more software modules such as software module 380.

The one or more input devices 350 can include a touch input device such as a keyboard, mouse, pen, trackball, touch screen, or game controller, a voice input device, a scanning device, a digital camera, or another device that provides input to the computing environment 300. The one or more output devices 360 can include a display, printer, speaker, or other device that provides output from the computing environment 300.

The one or more communication connections 370 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Some representative examples can be implanted as computer-executable instructions stored in computer-readable media. Computer-readable media include available media that can be accessed within a computing environment. By way of example, and not limitation, within the computing environment 300, computer-readable media include the principles of our invention with reference to described embodiments, it will be memory 320, storage 340, communication media, and combinations of any of the above.

Having described and illustrated representative embodiments, it will be appreciated that the described embodiments may be modified in arrangement and detail without departing from the principles of the disclosed technology. It should be understood that the programs, processes, or methods described herein are not limited to any particular type of computing environment, unless indicated otherwise. Various types of general purpose or specialized computing environments may be used with or perform operations in accordance with the teachings described herein. Elements of the described embodiments shown in software may be implemented in hardware and vice versa. In view of the many possible embodiments to which the principles of our invention may be applied, we claim as our invention all such embodiments as may come within the scope and spirit of the following claims and equivalents thereto.

We claim:

1. A method of secure conferencing, comprising:
validating at least one user based on a validation coupon provided by user equipment associated with the at least one user; and
transmitting an authorization associated with the at least one user based on the validation, wherein the transmitted authorization is associated with download of a media client.

2. The method of claim 1, wherein the media client is based on the validation coupon provided by the user equipment.

3. The method of claim 1, wherein the media client is configured to receive the validation coupon and determine that the media client is valid with respect to the validation coupon.

4. The method of claim 1, wherein the validation is associated with access to an application server, and the media client is configured to access the application server.

5. The method of claim 1, further comprising receiving a connection request associated with establishing communications with the user equipment based on the media client.

6. The method of claim 5, wherein the connection request is associated with providing conference data to the user equipment, and further comprising transmitting encrypted conference data to the user equipment, wherein the encrypted conference data is encrypted based on the validation coupon.

7. The method of claim 1, wherein at least one of the validation coupon and the user authorization is communicated via an Internet Protocol (IP) based network.

8. The method of claim 7, wherein the IP based network includes at least one of an IP multimedia subsystem network (IMS network) or a packet based network.

9. The method of claim 1, wherein the validation coupon includes at least one of a user identity, an equipment identity, and a shared key associated with a plurality of devices.

10. The method of claim 9, wherein the validation coupon includes a user identity and an equipment identity.

11. The method of claim 10, wherein the equipment identity is an International Mobile Equipment Identity (IMEI).

12. The method of claim 1, wherein the authorization is transmitted to the user equipment.

13. A user station, comprising:
a memory configured to store an equipment identifier associated with the user station; and
a transceiver configured to transmit a request for services that includes a validation coupon, wherein the validation coupon comprises the equipment identifier.

14. The user station of claim 13, wherein the transceiver is configured to receive a media client in response to the request, wherein the media client is based on the validation coupon.

15. The user station of claim 14, further comprising a processor configured to execute the media client such that data to be transmitted to the user station is validated based on the validation coupon prior to transmission, and the transceiver transmits an transmission authorization based on the data validation.

16. The user station of claim 15, wherein the equipment identifier is associated with user equipment for two or more users.

17. The user station of claim 16, wherein the transceiver is configured to receive the public identifier, and the processor is configured to store the public identifier in the memory.

18. The user station of claim 14, further wherein the processor is configured to receive encrypted data and decrypt the data based on the media client and the validation coupon.

19. An application server, comprising:
a validation module configured to receive a validation coupon and determine if a user is authorized to access services provided by the application server; and
a download module configured to communicate a media client to a user, wherein the download module configures the media client to process media data based on at least a portion of the validation coupon.

20. The application server of claim 19, further comprising a media control module configured to deliver the media data based on at least a portion of the validation coupon.

21. The application server of claim 20, wherein the media control module is configured to deliver the media data based on at least one of a public identifier and an equipment identifier.

22. The application server of claim 20, wherein the media data is audio data, video data, text data, or image data.

23. The application server of claim 22, media data is delivered based on a Real Time Transport Protocol or a Real Time Streaming Protocol.

24. An application server configured to provide conference data, the application server comprising:
a conference control module configured to distribute conference data;
a media client download module configured to authorize a plurality of user stations to download a valid media client upon successful validation of a validation coupon; and
a water mark module configured to encrypt the conference data using the validation coupon and communicate the encrypted data to the plurality of user stations.

25. The application server of claim 24, wherein the media client download module provides a media client configured to decrypt encrypted data provided by the application server.

26. The application server of claim 24, further comprising a filter module configured to receive the validation coupon and authorize download to the associated user and user station.

27. The application server of claim 24, further comprising a decoder for decrypting requests for services received from the user stations.

28. The application server of claim 24, wherein the valid media client includes a validator to determine if the conference data is valid with respect to the plurality of user stations, and the media client is configured to deliver the conference upon data validation.

29. The application server of claim 28, wherein the valid media client is configured based on a media key provided by a content provider.

30. A computer program product comprising a computer readable medium having a computer readable program code embodied therein for the method comprising:
validating a plurality of users for access to an application server based on validation coupons provided by a corresponding plurality of user stations;
enabling the plurality of user stations to download a valid media client from the application server after successful validation, wherein the valid media client for each user station is configured to decrypt conference data based on the validation coupon associated with the user station;
encrypting the conference data for each of the user stations using the validation coupons provided by the plurality of user stations;
downloading the encrypted conference data to the plurality of user stations; and
decrypting the conference data and coupling the decrypted conference to a user interface at each of the plurality of user stations.

31. The computer program product of claim 30, further comprising computer-readable program code for identifying the availability of a valid media client in the plurality of user stations based on a key provided by a content provider.
